(19) United States
(12) Patent Application Publication
(10) Pub. No.: US 2013/0213585 A1
(43) Pub. Date: Aug. 22, 2013

(54) PROFILE FOR A BOTTOM RAIL OF A ROLLER BLIND

(71) Applicant: Marko NENONEN, Lohja (FI)

(72) Inventor: Marko NENONEN, Lohja (FI)

(73) Assignee: ARVOMARKIISI OY, Espoo (FI)

(21) Appl. No.: 13/606,115

(22) Filed: Sep. 7, 2012

(30) Foreign Application Priority Data
Feb. 16, 2012 (EP) 12397504.7

(51) Int. Cl. E06B 9/42

(52) U.S. Cl. 160/23.1

(57) ABSTRACT

A profile for a bottom rail of a roller blind, which profile has a tubular shape with an inner surface and an outer surface. The wall of the profile is provided with a longitudinal groove at its outer surface for attaching a skirt of the roller blind in order to support the profile. The groove has a cross-section narrowing from its base towards the outer surface and the inner surface of the profile defines a space for a further roller blind, whereby the wall of the profile is provided with a longitudinal blind opening substantially opposite the groove.

### FIELD OF THE INVENTION

The present invention concerns roller blinds. More specifically, the present invention concerns a profile for a bottom rail of a roller blind.

### PRIOR ART

The use of roller blinds for covering windows or other openings is well known in the art. Roller blinds commonly comprise a roller supported by its ends. The roller is rotatably fixed to a window frame or a wall, etc. A blind is wound around the roller so that the blind can then be lowered or raised by rotating the roller.

The roller can also be located within a housing, also known as a roller box, in which case the roller is rotatably attached by its ends to the roller box. The roller box, in turn, is fixed to a window frame or a wall, for example.

Multiple roller blinds with different properties have also been used to cover the same opening. For example, multiple roller blinds with different opacities may be desirable for controlling the lighting conditions of a room. Constructions with one roller blind in front of another as well as constructions with one roller blind above another are both known.

Publication EP 2 216 490 A1 describes a roller blind system comprising of two independently controllable roller blind units with horizontally movable roller boxes located one above another whereby the free end of the uppermost blind is attached to the wall or window frame. In this system, each roller box is suspended with a cord arrangement, which requires that cord channels and cord channel covers are implement to the roller box. Furthermore, as the cord arrangement suspends the roller boxes only at their ends, the length of the roller boxes, and thus also the blinds, is limited due to bending of the roller boxes between their ends under their own weight.

### OBJECTS OF THE INVENTION

The object of the present invention is to provide a profile for a bottom rail of a first roller blind, which bottom rail further functions as a roller box for a subsequent roller blind needing no further suspension. This object is achieved by a tubular profile having a tubular shape with an inner surface and an outer surface, the wall of said profile being provided with a longitudinal groove at its outer surface for attaching a skirt of said roller blind Said groove has a cross-section narrowing from its base towards said outer surface. The inner surface of the profile defines a space for a further roller blind, whereby the wall of the profile is provided with a longitudinal blind opening substantially opposite said groove.

A bottom rail roller box constructed with a profile according to the present invention enables constructing a roller blind system where multiple roller blind units are attached one below the other. Furthermore, a bottom rail roller box constructed with a profile according to the present invention does not limit the width of a roller blind due to the bending of the bottom rail roller box, as the bottom rail roller box is supported along its length. Also, only few parts are needed for a bottom rail roller box constructed with a profile according to the present invention.

### BRIEF DESCRIPTION OF THE DRAWINGS

The present invention is described in detail hereafter with reference to the following figures, where:

FIG. 1 illustrates a cross section of a profile according to the present invention, and

FIG. 2 shows a perspective view of a profile according to the present invention.

It should be noted that the above mentioned figures are illustrated in a simplified manner for the purpose of clarity.

### DETAILED DESCRIPTION OF THE INVENTION

In the following description the words “length” and “width” are used with different meanings depending on what they refer to. The length of a profile, a roller box or a bottom rail corresponds to the width of roller blind.

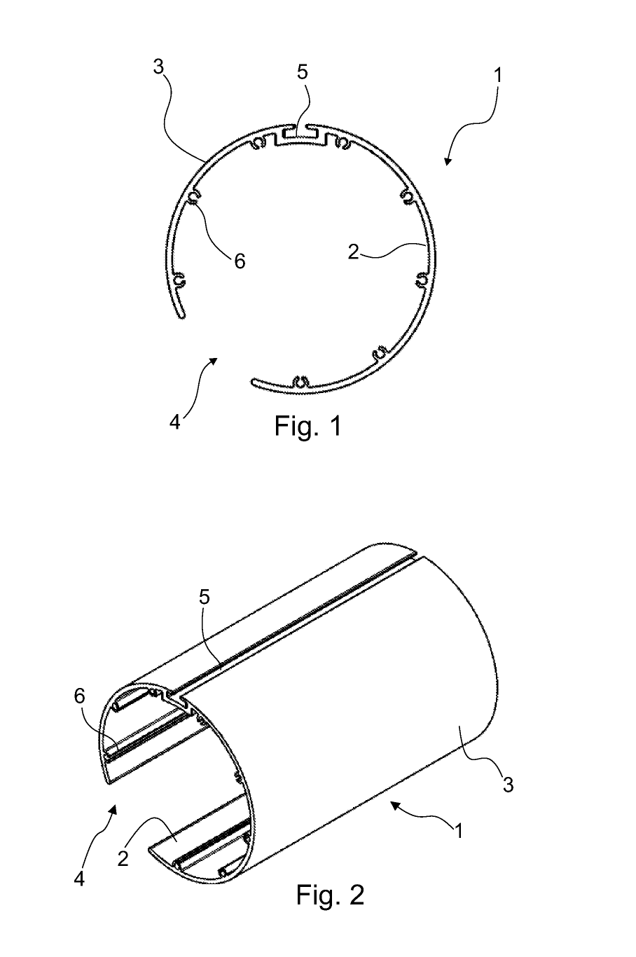

In FIG. 1 a cross-section of a tubular profile 1 can be seen. The profile comprises an inner surface 2, an outer surface 3, and a blind opening 4. On the outer surface 3 of the profile 1 there is a groove 5. Additionally, on the inner surface 2 of the profile 1 there are multiple grooves 6. In FIG. 2 a section of the profile 1 in its length direction is illustrated in perspective view.

The inner surface 2 of the profile 1 delimits an area into which a blind roller can be inserted. Advantageously the area delimited by the inner surface 2 is of a round shape. The outer surface 3 does not need to follow the shape of inner surface 2 as it does in FIG. 1 and FIG. 2.

The profile 1 is manufactured to a given length, substantially corresponding to the width of a roller blind suitable for covering a specific opening. A blind roller is fitted in the area delimited by the inner surface 2 of the profile 1. Both ends of the profile 1 are provided with end covers, from which the blind roller is rotatably suspended. The blind is led out of the profile 1 from the roller via the longitudinal blind opening 4. The blind may then be lowered and raised by rotating the blind roller. Different mechanisms known in the art, such as chain drives or remotely controllable electric motors with or without gearings and mounted inside or adjacent to the roller, may be used for rotating the blind roller.

According to the present invention, the profile 1 comprises a longitudinal groove 5 on the outer surface 2. The cross-section of the groove 5 does not need to be of the shape illustrated in FIG. 1 and FIG. 2. For attaching the profile 1 to a blind as a bottom rail, i.e. to be supported by the blind, the width of the groove's 5 cross section must narrow towards the groove opening on the outer surface 3. In other words, the slot formed on the outer surface 3 by the groove 5 is to be more narrow than the base of the groove 5.

There are several methods for attaching the profile to a blind as a bottom rail. The underlying basic principle is to increase the thickness of a section of the blind's skirt and inserting this section to the groove 5 from the side. In one method a pocket is formed to the skirt of the first roller blind, for example by folding and sewing the blind skirt. The pocket is then inserted in the groove 5 and then a strip is inserted to the pocket thus locking the blind to the profile 1. The strip should have a length according to the width of the first roller blind and a width small enough for the strip to fit in to the groove 5, yet the width of the strip should be greater than the width of the slot formed on the outer surface 3 by the groove 5. In an alternative method a strip is attached to the skirt of the first roller blind, e.g. by using two-sided tape, and the skirt along with the strip is inserted to the groove 5 from the side.

The strip should be dimensioned as described in connection with the previous attachment method, and additionally have a wedge-like cross section. Once the bottom rail is pulled away from the blind, for example due to the weight of the bottom rail, the strip acts as a wedge pushing the blind's skirt against the inside of the groove 5, thus locking the blind to the bottom rail.

As a bottom rail utilizing a profile according to the invention is supported by a blind above it, no further supporting means are required. In addition, the width of the roller blind inserted in the bottom rail, which acts also as a roller box, is not limited due to bending between its support points because the bottom rail is supported along its length. Furthermore, the bottom rail profile according to the invention enables two or more roller blinds to be subsequently attached one below the other, while the roller blinds can be operated between their fully wound and unwound positions independently from each other.

In an embodiment of the present invention, the longitudinal blind opening 4 is located so that the blind unwinding from the subsequent blind roller within the profile 1 does not touch the profile 1 at any point. This is achieved by forming the longitudinal blind opening 4 so that it extends in a horizontal direction pass the fully wound and respectively the fully unwound circumferences of the subsequent blind roller within the profile 1.

In a further embodiment according to the present invention, the profile comprises multiple longitudinal grooves 6 on its inner surface 2. These grooves 3 may also be formed by adjacent ribs leaving a narrow gap between them, as illustrated in FIG. 1 and FIG. 2. The end covers of the roller box may then comprise projections corresponding to the multiple grooves on the inner surface 2 for attaching the end covers simply by pushing them to the ends of the profile 1 and preventing the end covers from rotating. Alternatively the end covers can be attached by other means, such as screws, etc.

In another embodiment of the invention, the profile 1 is formed by extruding aluminum. In this way the profile may be manufactured and stored as a long piece, which is cut to specific size later on. Moreover, manufacturing the profile 1 by extruding aluminum enables complex shapes for the cross-section of the profile, thus making it possible to optimize the profile for different specific uses.

In still a further embodiment of the present invention, the profile is surface treated by powder coating or anodizing. Other surface treatment may also come into question, but the ones mentioned above have proven to provide good protection against environmental conditions.

1. A profile for a bottom rail of a roller blind, wherein:
said profile has a tubular shape with an inner surface and an outer surface;
a wall of said profile is provided with a longitudinal groove at its outer surface for attaching a skirt of said roller blind in order to support said profile, said groove having a cross-section narrowing from its base towards said outer surface; and
the inner surface of the profile defines a space for a further roller blind, whereby the wall of the profile is provided with a longitudinal blind opening substantially opposite said groove .

2. A profile according to claim 1, wherein said longitudinal blind opening is located on said profile so that a blind unwinding from said further blind roller does not touch said profile.

3. A profile according to claim 1 wherein said profile 1 further comprises multiple grooves on its inner surface for attaching end covers at the ends of the profile.

4. A profile according to claim 1, wherein said profile is formed by extruding aluminum.

5. A profile according to claim 1, wherein said profile is surface treated by powder coating or anodizing.
